(19) United States
(12) Patent Application Publication
(10) Pub. No.: US 2012/0273701 A1
(43) Pub. Date: Nov. 1, 2012

(54) Ergonomic Pneumatic Deadman Valve

(76) Inventor: Phuong Taylor Nguyen, Richmond, TX (US)

(21) Appl. No.: 13/542,522

(22) Filed: Jul. 5, 2012

Related U.S. Application Data
(63) Continuation of application No. 12/822,621, filed on Jun. 24, 2010, now abandoned.
Application No. 12/822,621 is a continuation of application No. 11/338,154, filed on Jan. 24, 2006, now abandoned.

(51) Int. Cl. F16K 35/02; F16K 31/60

(52) U.S. Cl. 251/98

(57) ABSTRACT

A lever actuated pneumatic deadman valve for use in connection with pneumatic blasting equipment is ergonomically designed to reduce fatigue and strain on the operator. The valve is shaped to fit comfortably in the hand of the operator, with a spring biased lever hinged for action to fit the natural movement of the hand. A detent button is sized and positioned for easily accommodating single-handed operation. Another important feature of the deadman valve is the reconfiguration of the valve cartridge with an offset port to produce a cyclonic flow around the spool for reducing the wear on the spool.

### CROSS-REFERENCE TO RELATED APPLICATIONS

This application is a continuation of application Ser. No. 12/822,621, filed on Jun. 24, 2010, which in turn, is a continuation of application Ser. No. 11/338,154, filed on Jan. 24, 2006 and claims priority from both of said applications, which are fully incorporated herein by reference.

### BACKGROUND OF THE INVENTION

### Discussion of the Prior Art

Deadman valves or switches are generally well known, and are used in a wide variety of industrial applications to operate devices or to prevent the operation of such devices. In fact, the Occupational Health and Safety Organization (OSHA) requires a safety system on all abrasive blasting equipment as well as on other equipment. Such safety systems usually include what is referred to in the art as a “deadman control.” A deadman control is a device that stops the machinery when the control is released. As is well known, these controls have been implemented as mechanical, pneumatic and electric deadman controls. In general, these valves or switches require prolonged actuation or actuation by a user who for one reason or another has part of his or her attention distracted from operation of the switch. Specifically, the operator is often focused on the operation of the system and takes the operability of the valve for granted.

The deadman valves are designed to function in a fail-safe mode wherein the valve or switch is automatically in the off position when certain conditions are not met. Typically, the failure to apply operating stimulus to the valve results in an immediate signal to shutdown. In a typical operation, the pneumatic deadman control system does not shut the system down immediately because of the inherent speed a pneumatic signal. The line, which could be 100 feet long, has to depressurize or vent, as well as the air cylinders in the air blast valves. While the action of the deadman venting or signal to shutoff is immediate, the time response from the air blast valve(s) is proportional to the length of signal line and the volume of the actuating cylinder or volume.

Such switches and valves are provided in many industrial applications such as blasting systems, power tools, industrial equipment and machinery and the like. The deadman valves are designed to prevent movement of the control device when the operator's attention is distracted from such a device. These valves permit operation of the device only when they are engaged and otherwise prevent the transmission of electrical, pneumatic, or hydraulic power to valves and other devices required to operate the machine.

The standard deadman valve comprises a simple push-button switch which is spring biased into its open position and which must be depressed into its actuated or closed position permitting operation of the device on which it is mounted. The typical valve is difficult to depress for extended periods of time because of fatigue.

One type of actuator for a deadman valve is the “mushroom” switch which requires less accurate positioning of the operator's hand. Another widely used configuration is the use of a control lever which is connected to the device on which the switch is mounted and which extends over the switch by a substantial distance and which may thus be more easily actuated. One such control lever is disclosed in U.S. Pat. No. 4,270,032, which issued to Dobberpuhl on May 26, 1981. The device is operated by deflecting the control lever against the biasing force of a return spring into contact with the switch, thus depressing and closing the switch and permitting operation of the machine. When the operator's hand is removed from the lever, the lever is returned to its initial position under the biasing force of the return spring, thus opening the switch and deactivating the device. Movement of the control lever in both directions is limited by a return stop.

### SUMMARY OF THE INVENTION

The subject invention is directed to a pneumatic deadman valve for use in connection with pneumatic blasting equipment. It is an important feature of the invention that the lever actuated valve is ergonomically designed to reduce fatigue and strain on the operator. Specifically, the valve shaped to fit comfortably in the hand of the operator, with the spring biased lever hinged for action to fit the natural movement of the hand. The detent button is sized and positioned for easily accommodating single-handed operation.

In the preferred embodiment of the invention, the pneumatic deadman valve comprises a base having a supply port, typically air supply and a signal port, with the valve mechanism being positioned between the ports to control on and off flow. In operation, flow will occur in both directions through the signal port. ON refers to flow towards the blast unit. OFF refers to flow away from the blast unit and vented under the handle or lever through the cartridge spool assembly. When the valve is engaged, the flow passes therethrough to activate the system. When the valve is released, it automatically shuts off flow to the outlet or signal port and vents the volumes connected to the signal port to atmospheric through the base, the cartridge, and the spool. Thus, allowing the hoses and valves in communication with the outlet or signal port to release pressure. Thereby, allowing the abrasive air blast valves to shut off. The base is designed to be comfortably held in one hand. The valve system includes a detent mechanism positioned in the base such that it may be engaged and depressed with a finger or thumb of the same hand holding the base. This can vary depending on the placement of the various lines or hoses connected to the valve. The actuator lever is sized to fit comfortably in the hand, with the hinge mechanism positioned at the wrist end of the hand, providing a natural movement for hand when depressing and engaging the lever, for reducing stress and fatigue. The spring for the detent button also acts indirectly through the taper on the detent button to push the handle or lever back up. The spool inside the cartridge utilizes pressure to push it up or to the OFF or vented position.

The resulting valve is an ergonomic configuration increasing the comfort level of the operator without sacrificing any functional features of the system.

In the preferred embodiment of the pneumatic deadman valve of the subject invention, the base is approximately 5.75-6.00 inches in length and between 0.75 and 1.400 inches in width for comfortably fitting in the palm of the average human hand. The actuator lever is approximately 5.00 inches long and 1.50 inches in width. The detent mechanism is a raised, rounded button approximately 0.50 inches in diameter. The full stroke of the lever is approximately 0.50 inches at the outboard end furthest from the hinge. The hinge is positioned between the detent button and the port end of the base.

Another important feature of the deadman valve of the subject invention is the reconfiguration of the valve cartridge with an offset port to produce a cyclonic flow around the spool, thereby reducing the wear on the spool, minimizing dead flow zones, and minimizing pressure drop.

The resulting valve is comfortable to handle and easy to use with single hand operation.

### BRIEF DESCRIPTION OF THE DRAWINGS

FIG. 1 illustrates the valve in a typical installation.

FIG. 2 is a perspective view of the valve of the subject invention.

FIG. 3 is similar to FIG. 2 with the actuator lever removed.

FIG. 4 is an exploded perspective view of the valve assembly.

FIG. 5 is a cross-sectional view of the valve cartridge and spool.

FIG. 6 is a cross-sectional view of the valve cartridge with the spool removed.

FIG. 7 is a cross-sectional view of the valve assembly, showing the cartridge installed therein.

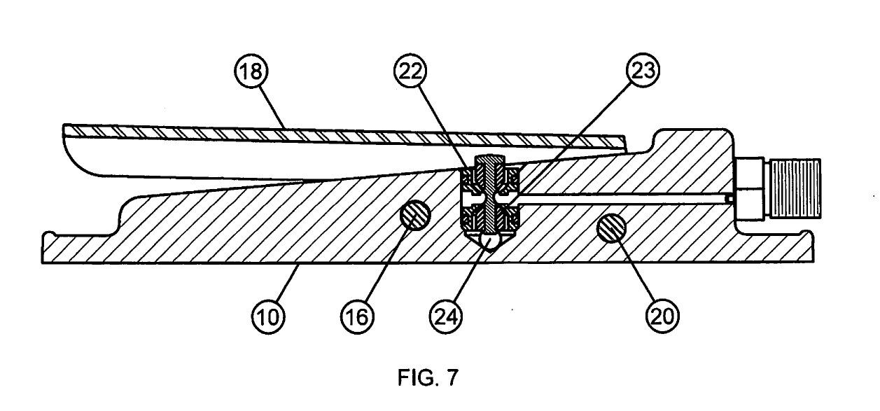

### DETAILED DESCRIPTION

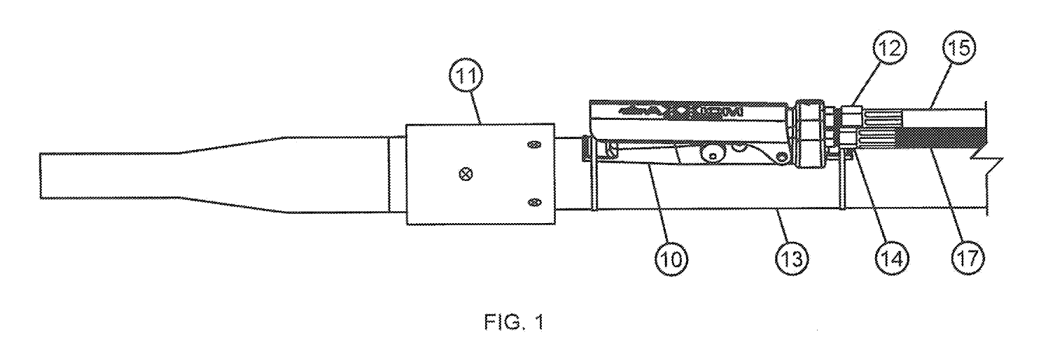

The deadman valve of the subject invention generally comprise a base 10 having a supply port 12 and a signal port 14 at one end, with a hinge pin 20 mounted in the base near said one end. A typical installation is shown in FIG. 1. The cylinder 11 is where the blast nozzles is attached. The large hose 13, below the base 10 is the blast hose where the abrasive and air mixture is conveyed from the air blast unit to the blast nozzle. The small hoses 15 and 17 are the supply and signal lines to the air blast unit, respectively.

A lever handle 18 is connected to the hinge and movable about the hinge between an outward VENT position and an inward ON position. A valve cartridge 22 is housed in the base 10 and is in communication with the supply and signal ports, the valve cartridge including a spool 23 movable between an ON and a VENT position for opening flow between the supply and signal port and venting pressure through the signal port. The spool includes an actuator tip 24 which is in engagement with the handle 18, whereby movement of the handle relative to the base 10 and cartridge 22 permits the spool to move between the ON and vent positions. A detent lock in the form of a spring return detent button 16 is mounted in the base 10 for fail-safe locking the lever handle and the spool in the closed or vent position. The detent is to prevent the valve from turning ON inadvertently. When the detent button is depressed, it will clear the way for the lever to swing down and push the spool to turn ON the system. If the handle 18 or lever is released, the detent button spring 28 will push the handle up thus allowing air pressure to push the spool 23 up or away from the base and vent the signal line to shut off air blast valves. The venting occurs through the cartridge 22 and spool 23 and under the handle 18 or lever.

In the preferred embodiment, the cartridge is located in the base between the hinge and the detent button. Preferably, the detent button is positioned such that it may be engaged without removing the hand from the base and handle, using the thumb or a finger.

It is desirable that the spool is designed to move axially relative to the cartridge, wherein the spool is of an hourglass shape for maximizing flow through the valve. In the preferred embodiment, the cartridge includes a flow port 42 in communication with the spool, wherein the flow port is off-center from the central axis of the spool and cartridge. More specifically, the spool and cartridge assembly includes a generally cylindrical cartridge having an internal bore, with the spool axially movable between the ON position and the OFF position in the central bore of the cartridge. The flow port in the cartridge is in communication with the spool, the flow port being off-center from the central axis of the spool and cartridge.

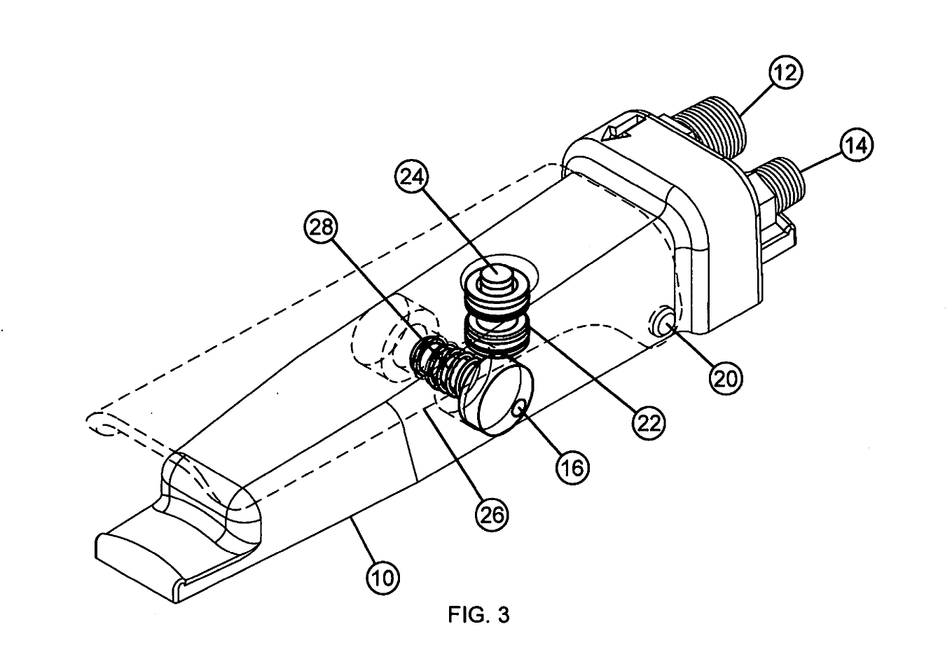

With specific reference to FIGS. 1-3, it can be seen that the valve assembly of the subject invention includes an elongated base or body 10 having an integral supply port 12 and an integral signal port 14. A spring return detent button 16 is positioned on the side of the base. An actuator lever 18 is hingedly mounted on the base by a hinge pin 20, located near the port end of the body. As better shown in FIG. 3, the valve cartridge 22 is positioned in the base with the spool 23 and tip 24 pressure-biased upwardly against the lever for normally holding the valve in an upward, vent or OFF position. The spool utilizes pressure to return it to the vent position when not depressed by lever. Force is created by pressure differential between the bottom and top (button and atmospheric) side of the spool. The spring 28 behind the detent button 16 pushes the button outward; thereby, pushing the handle 18 back up to allow spool 23 to lift and allow the signal port 14 to vent. The spring biased detent button 16 engages the lower edge 26 of the lever to lock the lever in this upward position.

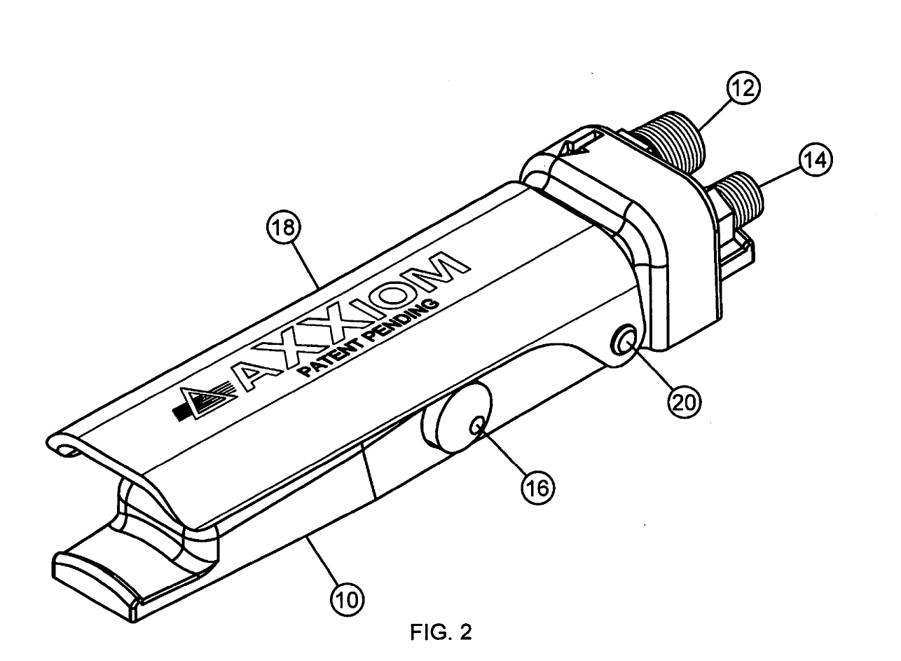

The valve, as shown in FIGS. 2-4, is designed to be held in the right hand with the palm on the lever 18 and the wrist toward the ports 12 and 14. This permits the operator to engage the detent button 16 without removing his palm and fingers from the lever and base, thus permitting single-handed operation. It should be noted that in common practice, air blast operators, use two hands to securely operate and handle the air blast nozzle.

By placing the hinge 20 between the ports 12, 14 and the detent button 16, the valve is activated by a natural squeezing motion, making the valve more comfortable to operate and reducing fatigue. The cartridge 22 is seated in the valve body 10 in receptacle 30. A pair of o-ring seals 31, 32 provide a seal between the cartridge 22 and the body 10. The spool 23 includes an outer tip 24 which is in contact with the actuating lever. A pair of spool seals 34, 36 are provided between the spool and the cartridge.

In the preferred embodiment, the base is approximately 5.75-6.00 inches in length and between 0.75 and 1.400 inches in width for comfortably fitting in the palm of the average human hand. The actuator lever is approximately 5.00 inches long and 1.50 inches in width. The detent mechanism is a raised, rounded button approximately 0.50 inches in diameter. The full stroke of the lever is approximately 0.50 inches at the outboard end furthest from the hinge.

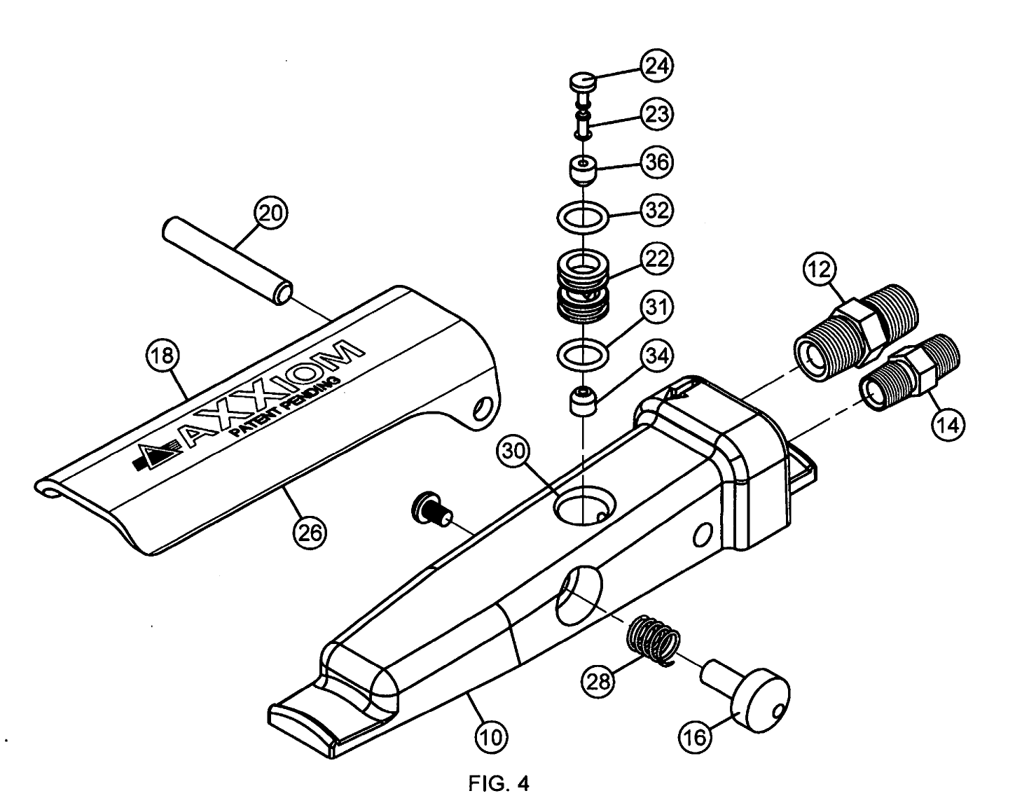

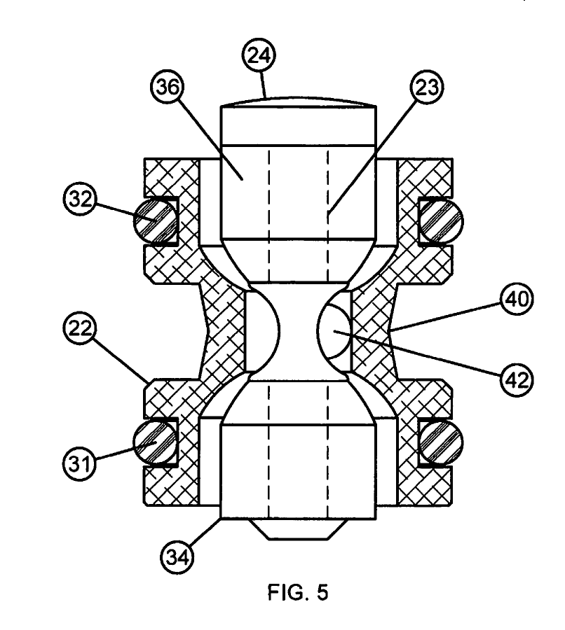

It is another important aspect of the invention that the cartridge and spool assembly has been reconfigured to minimize wear on the spool and extend the life of the valve. Turning now to FIGS. 4, 5 and 6, it can be seen that the spool 23 is generally of an hourglass configuration with the narrow mid-section 40 designed to move into and out of communication with the cartridge port 42 as the spool moves axially in the cartridge when engaged and released by the lever 18. It should be noted that port 42 is always in communication with port 14, the signal line. When the spool is up or towards the handle, signal port is communicated to atmospheric. When the spool is depressed by handle, port 42 is in communication with port 12 allow flow to turn on valves at air blast unit.

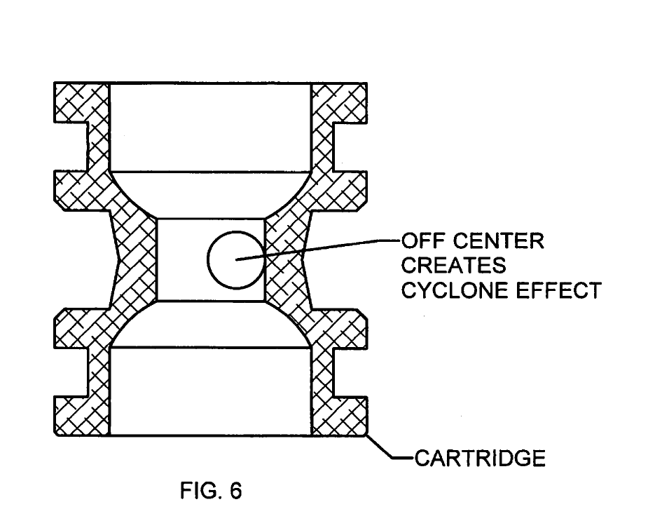

The hour glass cross-section permits maximum flow for the size of the valve bore. As best seen in FIG. 6, the port 42 is off-center. This creates a cyclonic flow around the hourglass spool, reducing wear on the spool by distributing the force generated by the pressure flow through the cartridge port.

The pneumatic deadman valve of the subject invention is ergonomically designed to reduce stress and fatigue experienced by the operator. Further, the flow system of the valve has been reconfigured to maximize flow and reduce wear on the valve spool. While certain embodiments and features of the invention have been described in detail herein, it will be recognized that the invention encompasses all modifications and improvements within the scope and spirit of the following claims.

1. A deadman valve, comprising:
a. A base having an supply inlet port at one end and an outlet port at the other end;
b. A hinge mounted in the base near said one inlet port end;
c. A lever handle connected to the hinge and extending toward the other outlet port end and movable about the hinge between an outward, closed position and an inward open position;
d. A valve cartridge housed in the base and in communication with the inlet and outlet port, the valve cartridge including a spool movable between an open and a closed position for opening and closing flow between the inlet port and the outlet port, the spool including an actuator tip which is in engagement with the handle, whereby movement of the handle relative to the base permits the spool to move between the open and closed positions; and
e. A spring biased detent button in the base for selectively locking the lever in and spool in the open position.

2. The valve of claim 1, wherein the detent type activation button is adapted to be engaged by the lever handle as it is moved from the closed to the open position, and wherein the cartridge is located in the base between the hinge and the detent button.

3. The valve of claim 1, wherein the detent button is positioned such that it is adapted to be engaged by the thumb or other finger without removing the hand from the handle.

4. The valve of claim 1, wherein the spool is designed to move axially relative to the cartridge and wherein the spool is of an hourglass shape for maximizing flow through the valve.

5. The valve of claim 1, wherein the cartridge having a flow port in communication with the spool, wherein the flow port is off-center from the central axis of the spool and cartridge.
